(19) United States
(12) Patent Application Publication
(10) Pub. No.: US 2017/0121487 A1
(43) Pub. Date: May 4, 2017

(54) CONTROL OF NANOPARTICLES DISPERSION STABILITY THROUGH DIELECTRIC CONSTANT TUNING, AND DETERMINATION OF INTRINSIC DIELECTRIC CONSTANT OF SURFACTANT-FREE NANOPARTICLES

(71) Applicants: KANEKA AMERICAS HOLDING, INC., Pasadena, TX (US); THE TEXAS A&M UNIVERSITY SYSTEM, College Station, TX (US)

(72) Inventors: Xi ZHANG, College Station, TX (US); Haiqing YAO, College Station, TX (US); Hung-Jue SUE, College Station, TX (US); Masahiro MIYAMOTO, Pasadena, TX (US)

(73) Assignees: KANEKA AMERICAS HOLDING, INC., Pasadena, TX (US); THE TEXAS A&M UNIVERSITY SYSTEM, College Station, TX (US)

(21) Appl. No.: 15/342,792

(22) Filed: Nov. 3, 2016

Related U.S. Application Data
(60) Provisional application No. 62/250,157, filed on Nov. 3, 2015.

(51) Int. Cl. C08K 3/04; C08K 3/22; C09C 1/44; C09C 3/08; C09C 1/04

(52) U.S. Cl. CPC C08K 3/04; C09C 3/08; C09C 1/043; C09C 1/44; C08K 3/22; C08K 2003/2296; C08K 2201/001; C08K 2201/011

(57) ABSTRACT

A composition including a medium and surfactant-free nanoparticles (SFNPs) at different dispersion state or aggregation form. The composition includes: (a) a composition of a medium and surfactant-free nanoparticles in primary form, wherein the dielectric constant value (DE value) of the medium is equal to or larger than the intrinsic dielectric constant value (IDE) of the SFNPs and smaller than about 1.5 times of the IDE of the SFNPs; (b) a composition of a medium and reaction-limited aggregation form of SFNPs, wherein the DE value of the medium is much larger than the IDE of the surfactant-free nanoparticles; (c) a composition of a medium and diffusion-limited aggregation form of SFNPs, wherein the DE value of the medium is smaller than the IDE of the surfactant-free nanoparticles; and (d) a composition comprising redispersible aggregation form of surfactant-free nanoparticles, wherein the surfactant-free nanoparticles are induced to aggregate in the diffusion-limited fashion in a medium with a DE value that is smaller than the IDE of the surfactant-free nanoparticles.

### CROSS-REFERENCE TO RELATED APPLICATIONS

The present application is based upon and claims the benefit of priority to U.S. Provisional Application No. 62-250157, filed Nov. 3, 2015, the entire contents of which are incorporated herein by reference.

### NOMENCLATURE

SFNPs—surfactant-free nanoparticles, i.e., primary synthesized or pretreated nanoparticles which exist mainly as individual nanoparticles without any stabilizing surfactant. If such a surfactant is used to obtain the primary nanoparticles during the pretreatment or synthesis, the surfactant will be removed prior to application of the said invention.

SFNP colloid—A media containing SFNPs.

Media—A media or a mixture of media where the SFNPs are being incorporated.

Intrinsic DE value (IDE)—the dielectric constant of the SFNPs without surface ionization.

Embodied DE value (EDE)—the dielectric constant of the SFNPs where the surface of the SFNPs is ionized or exposed to an external field.

### FIELD OF THE INVENTION

The present invention relates in general to quantification of the surface characteristic of SFNPs, to correlating the dispersion state of SFNPs in a media to the specific surface characteristic, to the control of the dispersion and aggregation state of the SFNPs in a media, and to the transfer of nanoparticles to a different media. The invention further relates to the quantification of the IDE values of the SFNPs and correlation of the dispersion state of the SFNP colloid to the DE values of the SFNPs and the media.

### SUMMARY OF THE INVENTION

A method of measuring the intrinsic dielectric properties of SFNPs dispersed in media is developed, as well as a method of stabilizing NPs through dielectric constant tuning of the media. To determine the media polarity that causes the SFNPs to ionize, SFNPs are introduced in a series of media with increasing polarity to compare between the dielectric properties of the media and that of the NP colloids. At the divergence point, the media and the SFNPs are considered to have similar electromagnetic field and, therefore, matching dielectric properties. The SFNPs are found to be stabilized in the media of approximately similar or slightly larger polarity. The methodology is illustrated using zero-dimensional (0-D), one-dimensional (1-D), and two-dimensional (2-D) NPs, and various NP hybrids. The obtained stable dispersion of SFNPs in chosen media can then be transferred to a polymer matrix with maintained stable dispersion state.

### BRIEF DESCRIPTION OF THE DRAWINGS

FIG. 1 is a comparison of the dispersion of purified ZnO SNFPs in various binary mixtures containing methanol and dichloromethane. FIG. 1 shows purified ZnO SFNPs dispersed in binary mixture of methanol and dichloromethane, where φ(methanol)=0, 0.10, 0.20, 0.30, 0.40, 0.50, 0.60, 0.70, 0.80, 0.90 and 1.0 from left to right. As illustrated, the ZnO SFNPs remain well dispersed near the 50:50 mixture range and enter diffusion-limited regime and reaction-limited regime towards left and right, respectively.

FIG. 2 is a graph showing the UV-vis spectra of the dispersed ZnO SNFPs in various binary mixtures containing methanol and dichloromethane. The graph shows UV-vis spectra of ZnO-M0, ZnO-M10, ZnO-M20, ZnO-M30, ZnO-M50, ZnO-M70 and ZnO-M100.

FIG. 3 is a comparison of the dispersion of ZnO SNFPs in ZnO-M50 immediately after preparation with fused ZnO NP dimers in ZnO-M50 after 1 month time. (A) and (B) are ZnO SFNPs in ZnO-M50 immediately after preparation and (C) and (D) are fused ZnO NP dimers in ZnO-M50 after 1 month.

FIG. 4 is a graph showing the dielectrometry profiles of ZnO SFNPs in various binary mixtures containing methanol and dichloromethane.

FIG. 5 is a pair of graphs showing interparticle potential profiles between SFNPs at media of different DE values.

FIG. 6 is a comparison of individual SWCNTs dispersed in various solvents. FIG. 6 shows individual SWCNTs dispersed in water, methanol, ethanol, ethanol-hexane mixture with a 1 to 0.9 volume ratio, and n-hexane.

FIG. 7 is a comparison of TEM micrographs of the SWCNTs dispersed in ethanol (left) and ethanol-hexane mixture (right).

FIG. 8 is a comparison of the dispersion of purified ZrP in various binary mixtures containing ethanol and DI H₂O; the dispersed purified ZrP in various binary mixtures containing ethanol and DI H₂O after 16 months time; and ZrP—K nanoplatelets in DI H₂O. (A) As prepared dispersion of purified ZrP in binary mixture of ethanol and DI H₂O with φ(H₂O)=0, 0.25, 0.33, 0.5, 0.67, 0.75, 0.80, 0.83, 0.86, 0.89 and 1.0 from left to right. (B) 16 months after preparation, purified ZrP in binary mixture of ethanol and DI H₂O with φ(H₂O)=0.33, 0.5, 0.67, 0.75 and 0.80 from left to right. (C) ZrP—K nanoplatelets in DI H₂O.

FIG. 9 is a dielectrometry measurement of purified ZrP in various binary mixtures containing ethanol and DI H₂O. FIG. 9 shows dielectrometry measurement (A) and electrophoretic mobility measurement (B) of purified ZrP in binary mixture of ethanol and DI H₂O.

FIG. 10 is a comparison of TEM micrographs of 50 wt. % purified ZrP in PVA, in an ethanol-H₂O mixture versus in H₂O. (A) The mixing solvent is ethanol—H₂O mixture with a φ(H₂O)=0.67 and (B) the mixing solvent is H₂O.

FIG. 11 is an illustration of liquid exfoliation of graphene with assistance of ZrP nanoplatelets and sonication; a comparison of graphene dispersed in various binary mixtures of H₂O and isopropanol; a graph of the amount of graphene stabilized by these various binary mixtures; and TEM micrographs of the obtained graphene material. (A) Schematic illustration of liquid exfoliation of graphene with assistance of ZrP nanoplatelets and sonication. (B) Photographs of graphene redispersed into binary mixture of H₂O and isopropanol, from left to right, φ(isopropanol)=0, 0.3, 0.5, 0.7 and 0.9. (C) The amount of graphene that can be stabilized by different H₂O-isopropanol mixture. (C and D) TEM micrographs of the obtained graphene material.

FIG. 12 is a comparison of MWCNTs in various solvents and a TEM micrograph of the MWCNTs in 2-butanol; CNT2Zn01 hybrid NPs in various solvents and a TEM micrograph of the hybrid NP in 1-butanol; and CNT1Zn01 hybrid NPs in various solvents and a TEM micrograph of the hybrid NP in 2-propanol. (A) Photograph of MWCNTs in 2-propanol, 1-butanol, 2-butanol and 1-pentanol (from left to right and hereinafter) and the TEM micrograph of MWCNTs in 2-butanol. (B) Photograph of CNT2ZnO1 hybrid NPs in ethanol, 1-propanol, 1-butanol, 1-pentanol, 1-hexanol and 1-heptanol and TEM micrograph of the hybrid NP in 1-butanol. (C) Photograph of CNT1ZnO1 hybrid NPs in ethanol, 1-propanol, 2-propanol, 1-butanol, 1-pentanol & 1-hexanol and TEM micrograph of the hybrid NP in 2-propanol.

FIG. 13 is a comparison of ZnO SNFPs in various solvents after being transferred from methanol-dichloromethane solvent mixture at different times. FIG. 13 shows photographic images of ZnO SFNPs in various solvents after being transferred from methanol-dichloromethane solvent mixture: (A) immediately after preparation, (B) 2 hours later, (C) 4 days later and (D) 8 days later. [ZnO]=0.4 M. The solvent media are 1-butanol, 1-pentanol, 1-hexanl, 1-heptanol and 1-octanol from left to right.

FIG. 14 is a graph showing the UV-vis spectra of the ZnO SFNPs transferred into various solvents, and a graph showing the UV-vis spectra of the ZnO/1-heptanol dispersion at different times. FIG. 14 shows UV-vis transmission spectra of (A) ZnO SFNPs transferred into 1-butanol, 1-pentanol, 1-hexanl, 1-heptanol and 1-octanol, and (B) ZnO/1-heptanol dispersion at different times

### BACKGROUND OF THE INVENTION

SFNPs are known to be different from bulk materials in thermodynamics, surface characteristics and electromagnetic and electro-optical properties. Compared to bulk materials, individual SFNPs have faster diffusion rate, higher surface-area-to-volume ratio, and often a wider band-gap structure for electron transport, making them useful and effective in various applications. However, it is also extremely difficult to characterize their surface properties and manipulate their stability in desired media. For example, one decisive parameter of the electromagnetic properties of the SFNPs is the DE value, which has not been well characterized to our knowledge. Due to the restriction of the dielectrometry technique, the measurement of the DE value of SFNPs has been limited to the NP powder where the SFNPs exist in an aggregated form (reference 1); the collective electromagnetic state of the NP aggregates does not reflect the intrinsic electromagnetic state of individual SFNPs.

A reliable measurement of the DE value of individual SFNPs offers not only useful information about SFNPs but also a powerful means to manipulate the interparticle forces, and therefore their dispersion and aggregation behavior in the media of interest. The van der Waals (vdW) force originates for the electromagnetic field interaction between SFNPs (reference 2). It has also been reported that environmental electromagnetic field affects the surface ionization of SFNPs, therefore contributing to the variation in interparticle electric repulsion forces (reference 3). Consequently, the stability of SFNPs in a media can likely be controlled if these two competing forces are well adjusted.

The difficulties in determining the DE value of individually dispersed NPs involve two known facts. One is the difficulty in eliminating usage of stabilizing agents, such as a surfactant, ligand or grafted macromolecules, while keeping the SFNPs dispersed in an individual form. The other difficulty is the inability to perform direct DE measurement of individually-dispersed NPs using current dielectrometry technique. In this invention, we propose a method to semi-quantitatively determine the IDE value of individually dispersed SFNPs by examining their EDE values, which correspond to the levels of surface ionization in different media. The dispersion state and aggregation behavior of the NP colloids is then correlated to the dielectrometry profiles.

### Detailed Description and Preferred Embodiment of the Invention

1. Stability of 5-nm zinc oxide (ZnO) colloids

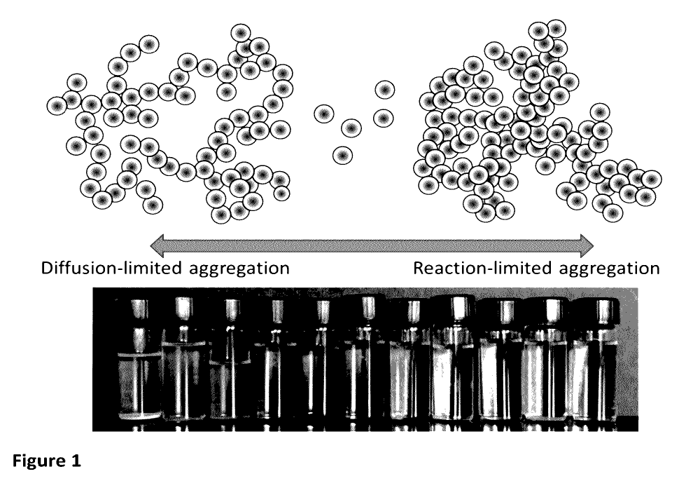

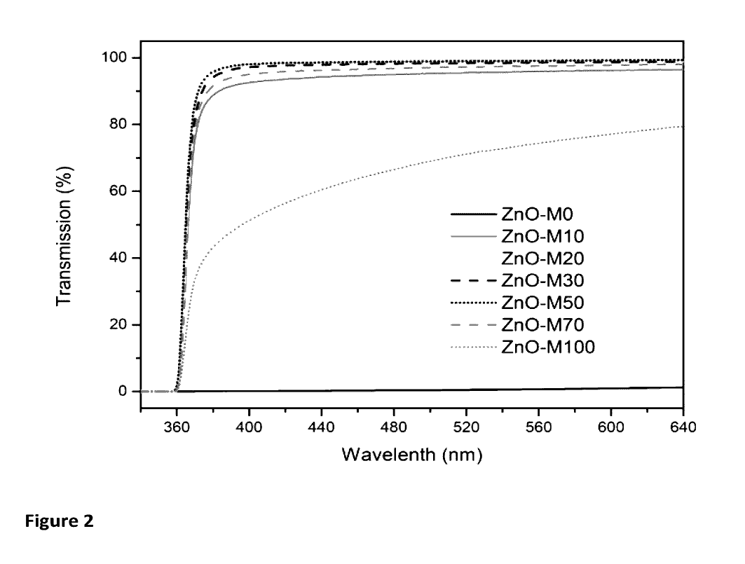

Monodisperse ZnO SFNPs with a diameter of 5 nm were synthesized and purified using previously established method (reference 4). Afterwards, the ZnO SFNPs were re-dispersed in a series of 4 ml mixture of methanol and dichloromethane with a ZnO concentration ([ZnO]) of 4 mM and volume fraction of methanol (φ(methanol)) that equals 0, 0.10, 0.20, 0.30, 0.40, 0.50, 0.60, 0.70, 0.80, 0.90 and 1.0. The re-dispersed colloidal ZnO is denoted as ZnO-M0, ZnO-M10, ZnO-M20, . . . , ZnO-M90 and ZnO-M100. The samples were closely observed at room temperature to determine their stability. It is found that the ZnO-M50 is most transparent and stable over time compared with other systems, which suggests that the ZnO SFNPs are well dispersed (FIG. 1). This finding is in agreement with the UV-vis spectra, which also demonstrates that the ZnO-M50 is most transparent (FIG. 2). It is also found that the ZnO SFNPs in ZnO-M0, ZnO-M10, ZnO-M20 precipitate quickly after sample preparation and possesses a redispersible loose form, which is a typical aggregation process that is determined by NP diffusion rate. On the contrary, the ZnO SFNPs in ZnO-M100, ZnO-M90 and ZnO-M80 agglomerates sediment slower and form a compact aggregate, which implies these systems follow a reaction-limited aggregation path. The two different aggregation forms are illustrated by the insets.

2. Characterization

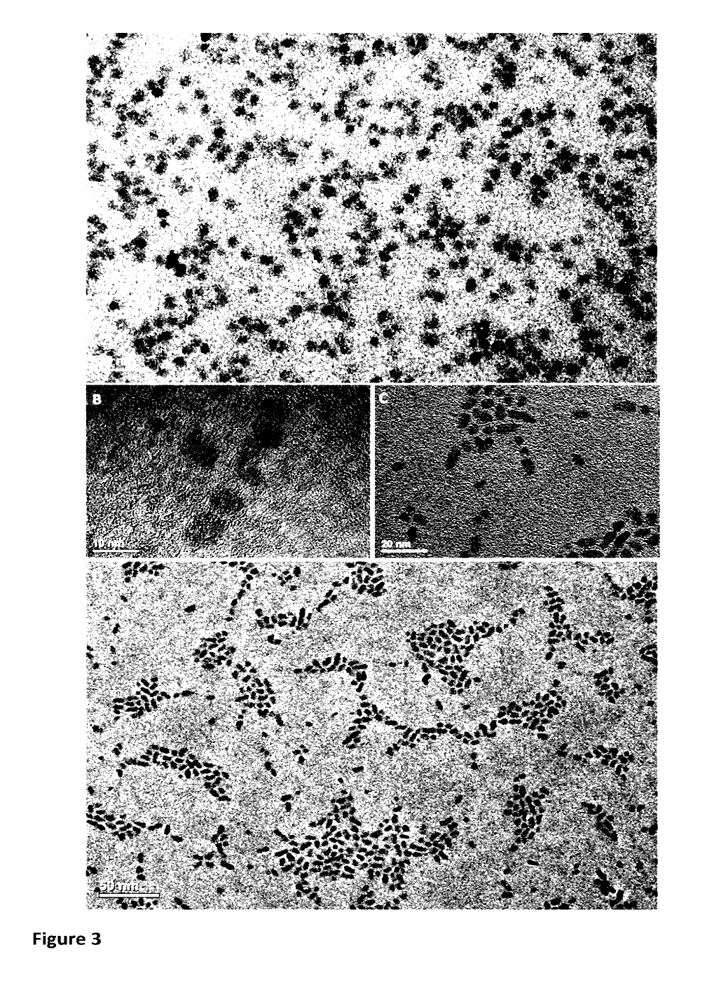

Transmission electron microscopy (TEM) was used to confirm the dispersion state of the ZnO SFNPs in ZnO-M50. As prepared, almost all ZnO SFNPs were individually dispersed (FIG. 3A). Interestingly, in some regions, the SFNPs tend to align along the same lattice direction (FIG. 3B), which is likely due to the alignment of the electromagnetic field of the atomic Zn—O bonding, which is much stronger than the interparticle force. To our knowledge, the ZnO-M50 presents the best long-term stability of ZnO SFNPs without using surfactants. It is noted that the ZnO-M50 dispersion became slightly hazy after one month of storage. At this point, almost all ZnO SFNPs are fused into short rods with an average length of about 2 SFNPs (FIG. 3C) and appear to remain uniformly dispersed (FIG. 3D).

3. Dispersion Mechanism—Dielectrometry Analysis

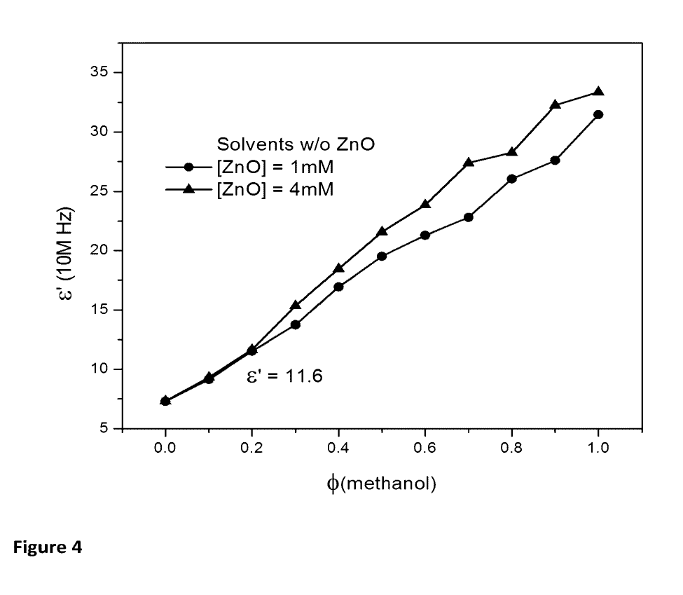

In order to understand the dispersion mechanism, dielectrometry was performed on the above-mentioned ZnO colloids (triangle-point curve) and the solvent mixture alone without ZnO (circle-point curve), as shown in FIG. 4. As expected, the DE value of the solvent mixture increases with the more polar methanol component. There is no difference between the DE value of the solvents and the ZnO colloids when φ(methanol) is below 0.2 and the DE of the media is less than 11.6. This is likely due to the low concentration of ZnO, which cannot cause a detectable change in DE of the colloids. Interestingly, when φ(methanol) exceeds 0.2, the DE value of ZnO colloids becomes larger than that of the corresponding solvents, and the DE enhancement increases dramatically as the φ(methanol) increases. This suggests that the DE value of ZnO SFNPs does not remain the same as solvent polarity changes. Otherwise, the DE variation between the solvents and ZnO colloids should have a positive-neutral-negative transition. On the contrary, the dielectrometry results indicate that the ZnO SFNPs have actually become much more polar and have a much stronger electromagnetic polarization in solvents with DE over 11.6 even at such a low ZnO loading. The strengthening of the ZnO electromagnetic polarization is due to surface ionization of the ZnO SFNPs at the particle-solvent interface in polar solvents. This will be demonstrated later with 2-D NPs using zeta potential measurement. A similar trend was also observed in more diluted ZnO colloids ([ZnO]=1 mM, red curve). However, the onset of divergence of the DE between the media and the ZnO colloids is less differentiable, which probably reflects the resolution of this technique. Nevertheless, the overall trend indicates that surface ionization of the ZnO SFNPs likely begins when φ(methanol) exceeds 0.2 and the DE of the media goes above 11.6. Since induced ionization can only occur when the surrounding electromagnetic field deviates from that of the SFNPs, the point the DE begins to deviate from the media reflects an intrinsic physical property of the SFNPs, which can be considered as the intrinsic dielectric constant (IDE) of the SFNPs. The value is slightly larger than the 10˜11 DE value of bulk ZnO materials reported in literature ⁵, which is probably due to the surface defect on the SFNPs. The approach described above can thus be used to measure the IDE of various SFNPs, if appropriate solvents are utilized.

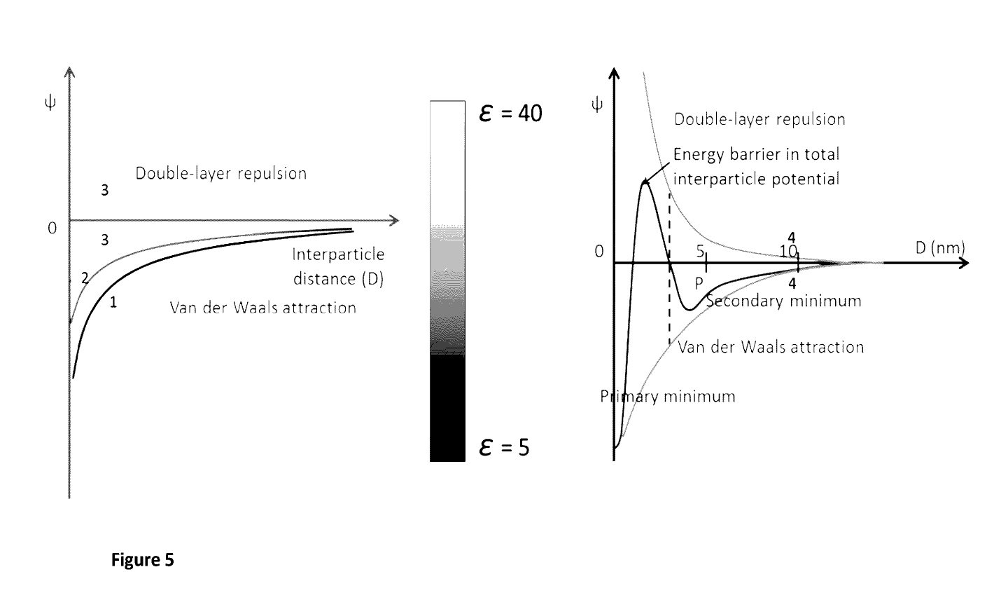

Combining the dielectrometry results and observation on the dispersion stability of the ZnO colloids, the following model of particle dispersion based on DLVO (Derjaguin-Landau-Verwey-Overbeek) theory is proposed and illustrated in FIG. 5:

a) By eliminating the use of surfactants, the steric repulsion is minimized. Therefore, between SFNPs, there only exist vdW attraction and electrical double-layer (EDL) repulsion. SFNPs at close proximity always have dominant vdW attraction and tend to aggregate. At far distance, the kinetic movement of SFNPs is random and is driven by thermal energy.

b) When the media is less polar than the SFNPs, i.e., the DE of the media is below the IDE of the SFNPs, the surface ionization of the SFNPs is suppressed therefore the EDL repulsion is limited ³. If the DE of the media is much lower than that the IDE of the SFNPs (line 1), the mismatch between the electromagnetic field induces a strong vdW attraction that leads the SFNPs to aggregate. The aggregation process is determined by how fast the SFNPs diffuse, thereby a diffusion-limited process. As the DE of the media increases and approaches the IDE of the SFNPs, the mismatch of the electromagnetic field attenuates and the vdW attraction decreases (line 2), causing the SFNP colloids to become more stable, e.g., the ZnO-M0, ZnO-M10 and ZnO-M20 showed a decreasing amount of precipitation after preparation.

c) When the DE of the media is larger than the IDE of the SFNPs, EDL repulsion begins to appear as a result of the surface ionization of the SFNPs, which at some point can counter the vDW attraction from the electromagnetic field mismatch between the SFNPs and the media to maintain a long-term stability of the SFNP colloids as in ZnO-M50 (lines 3).

d) When the DE of the media is significantly larger than the IDE of the SFNPs, the surface ionization of the SFNPs is further enhanced that there exists a stronger EDL repulsion. However, the mismatch of the electromagnetic filed is so large that the increased EDL repulsion can no longer cancel out the vdW especially when SFNPs are at a close distance (lines 4), rendering a total attractive interparticle force and cause the SFNPs to aggregate. In the meantime, the energy barrier caused by EDL repulsion before the SFNPs aggregate give the aggregation process a reaction-limited characteristics as in ZnO-M100.

4. 1-Dimensional (1-D) SFNPs

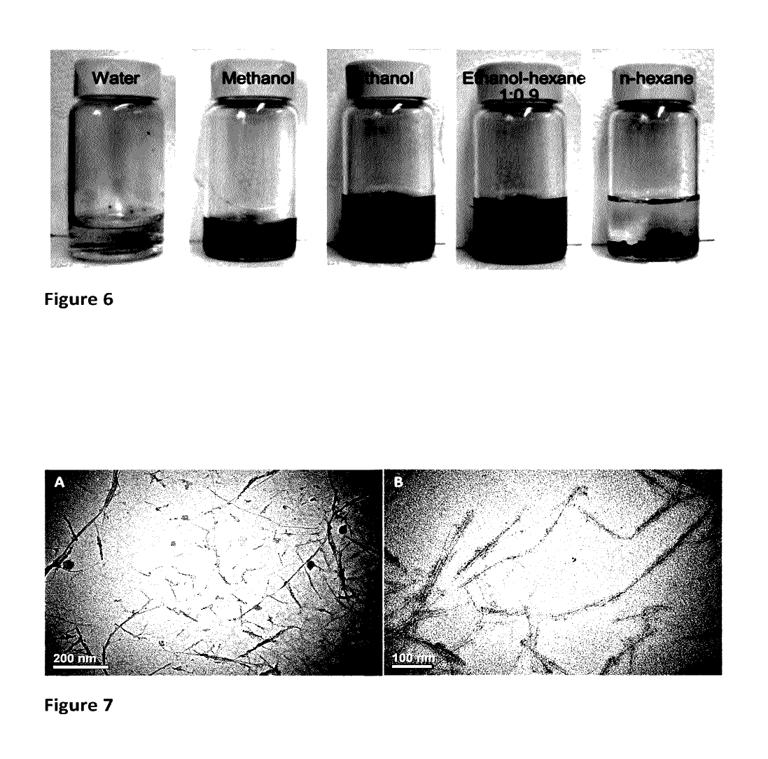

We have further extended the above approach to stabilize SFNPs other than spherical NPs, such as rod-like or tube-like one-dimensional (1-D) SFNPs and disk-like or sheet-like two-dimensional (2-D) SFNPs. Carbon nanotubes (CNTs) is a well-known 1-D NPs that tend to form bundles or entanglement by itself. Surfactants or polymeric stabilizer have been used frequently to stabilize the CNTs. Here, we demonstrate that without using any stabilizing agents, CNTs can be stabilized by solvent alone provided that the chosen solvent has a suitable dielectric property. Individualized surfactant-free single-walled CNTs (SWCNTs) were obtained by using ZrP to exfoliate pristine CNT bundles, followed by ZrP removal (references 6 and 7). Afterwards, the SWCNTs were transferred to various solvents including methanol, ethanol, ethanol-hexane mixture and hexane (FIG. 6). SWCNTs in hexane precipitate immediately after preparation. While in methanol, SWCNTs precipitate within 24 hours (not shown). The observation indicates that water, methanol and n-hexane individually are not good solvent for SWCNTs. The visual appearances of SWCNTs in ethanol and ethanol-hexane mixture appear similar. Hence, TEM has been performed to examine their possible morphological difference.

As shown in FIG. 7, the SWCNTs dispersed in ethanol exist primarily as individual nanotubes but small bundles of SWCNTs can also be observed. On the contrary, the SWCNTs dispersed in ethanol-hexane mixture are all present as individual tubes. Therefore, the ethanol-hexane mixture with a 1 to 0.9 volume ratio is a good solvent for dispersing surfactant-free individual SWCNTs and the individual SWCNTs likely to have similar dielectric property to the specific solvent mixture.

5. 2-D SFNPs

Examples shown here for 2-D SFNPs that can be stabilized by solvent alone are α-zirconium phosphate (ZrP) nanoplatelets and graphene nanosheets. To obtain exfoliated ZrP nanoplatelets without surfactants, pristine ZrP nanoplatelets were first synthesized and exfoliated in water by tetrabutylammonium hydroxide (TBA) using a previously reported method ^{8, 9}. Acid or salts were then used to neutralize and remove TAB and cause the nanoplatelets to aggregate. The coagulated nanoplatelets were washed 3 or 4 times with deionized water (DI H₂O) to remove acid (or salts) and TBA residue. The purified ZrP was dispersed in a series of mixture of DI H₂O and ethanol with a ZrP concentration of 0.5 mg/ml and volume fraction of DI H₂O (φ(H₂O) equals to 0, 0.25, 0.33, 0.5, 0.67, 0.75, 0.80, 0.83, 0.86, 0.89 and 1.0.

To prepare potassium-ion-exchanged Zr(KPO₄)₂ (ZrP—K), the purified ZrP nanoplatelets were immersed in diluted KOH aqueous solution for 30 min and washed with DI H₂O for 3 or 4 times to remove additional KOH. The modified nanoplatelets containing K⁺ in the ZrP structure were then re-dispersed in different solvents via sonication.

XPS was used to quantify the chemical composition of the exfoliated ZrP nanoplatelets and their derivatives. Table 1 lists the atomic ratios of Zr, P, K (if any), O, and C elements of nanoplatelets treated differently after being normalized by the amount of Zr element in the system. The superscript “e” denotes the experimental value and the superscript “t” denotes the theoretical value of the chemical structures of Zr(PO₄)₂K₂ (ZrP—K), Zr(HPO₄)(PO₄)—C₁₆H36 (ZrP-TBA conjugated at a molar ratio of 1:1), and Zr(HPO₄)₂·H₂O (i.e., purified ZrP) nanoplatelets. The large C content in ZrP-TBA obviously comes from the TBA molecule. After using acid to neutralize TBA, the C content is significantly reduced in the purified ZrP nanoplatelets, indicating the detachment of TBA molecules from the nanoplatelet surfaces. A comparable amount of K to that of P and Zr in ZrP—K nanoplatelet verifies the presence of K⁺ on the nanoplatelet structure. The chemical structure of the product is likely to be Zr(PO₄)₂K₂ after the HPO₄²⁻ reaction with KOH.

TABLE 1
Chemical compositions of various modified ZrP nanoplatelets.

| | Atomic ratio | | | | |
|---|---|---|---|---|---|
| | P^{e}/P^{t} | Zr | K^{e} | O^{e}/O^{t} | C^{e}/C^{t} |
| ZrP-K | 1.5/2 | 1 | 1.6 | 7.4/9 | 3.4/0 |
| ZrP-TBA | 2.0/2 | 1 | NA | 8.7/9 | 13/12.8 |
| ZrP | 1.9/2 | 1 | NA | 8.4/9 | 5.6/0 |

* The superscript “e” denotes the experimental value and the superscript “t” denotes the theoretical value of different ZrP derivatives.

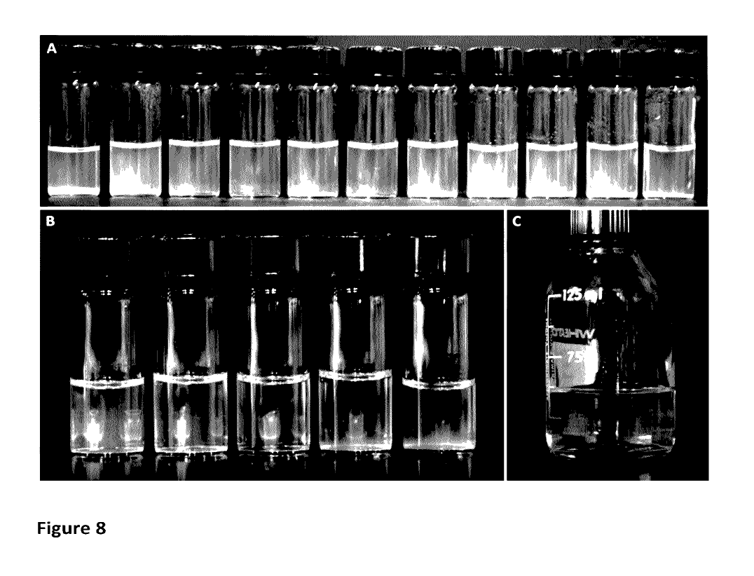

As shown in FIG. 8, pristine ZrP nanoplatelets without TBA-assisted exfoliation cannot form a stable dispersion. However, with the same chemical composition, the purified ZrP prepared by exfoliation with TBA and TBA removal has been found to be stable in a mixture of DI H₂O and ethanol with φ(H₂O)=0.67. The dispersion has a similar appearance compared with adjacent dispersions of different solvent mixtures when freshly prepared (FIG. 8A), but the solvent containing φ(H₂O)=0.67 is the only one without showing any precipitation after 16 months (FIG. 8B). The results indicate that exfoliated nanoplatelets do not restack into a highly ordered layered structure even after the detachment of TBA molecules. On the contrary, the ligand-free nanoplatelets aggregate forms loosely packed structure in its wet state, which allows the re-dispersion of the purified nanoplatelets by matching its electromagnetic field with that of the solvent. It is noted that the ZrP—K nanoplatelets remain stable in water without any noticeable change after 10 months (FIG. 8C).

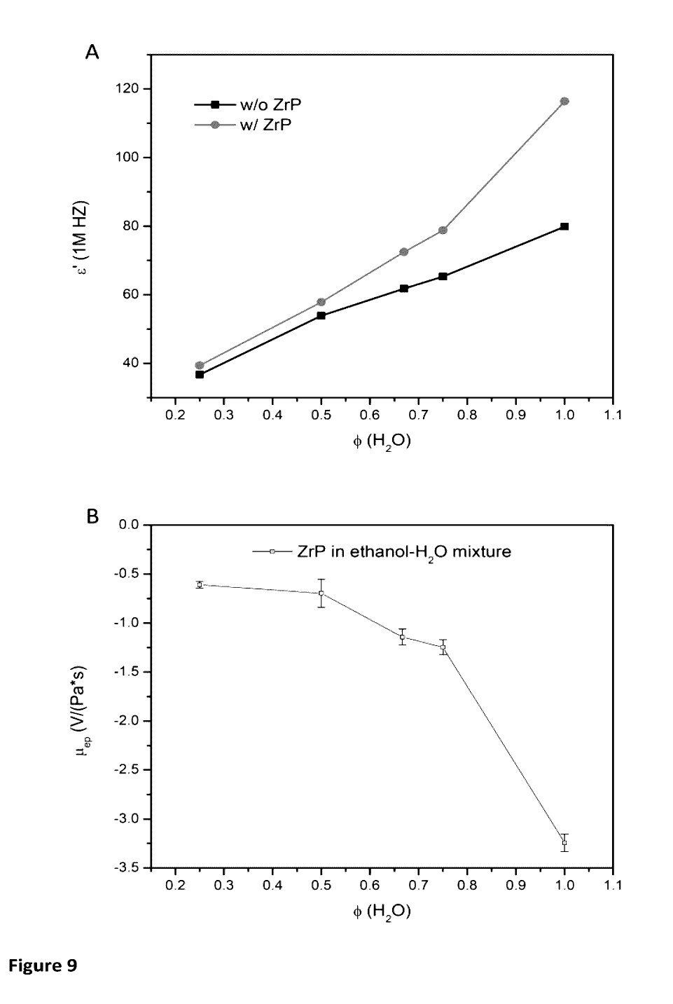

The above observation also agrees with the dielectrometry measurement (FIG. 9A). Concentrated mixture with ZrP ([ZrP]=3.0 mg/ml, red curve) has a similar DE value to that of ethanol-H₂O mixture without ZrP (black curve) until φ(H₂O) exceeds 0.5. At the deviation point, the DE value of the solvent is 54 (measured at 1M HZ). Therefore, the approximate DE value of individual surfactant-free ZrP nanoplatelet is likely to be the same and at this point, the stability of the ZrP dispersion is significantly improved due to minimized vdW attraction. Beyond this point, the surface ionization of ZrP is enhanced and EDL repulsion begins to contribute to the particle stabilization. At φ(H₂O)=0.67, attraction force and repulsion force are properly compensating each other and the stability of the surfactant-free ZrP is optimized. Therefore, by matching the dielectric property of the solvent and the 2-D particles, a stable dispersion of the particles can be achieved without using surfactant.

The enhancement of surface ionization of ZrP beyond φ(H₂O)=0.5 has been demonstrated using zeta potential measurement. As a direct indicator of the degree of surface ionization, the electrophoretic mobility (μₑₚ) of ZrP at different binary ethanol-H₂O mixture was obtained through zeta potential measurement and is plotted in FIG. 9B. The result agrees well with the dielectrometry measurement. While the value of μₑₚ remain similar between φ(H₂O)=0.25 and φ(H₂O)=0.5, suggesting no significant surface ionization, noticeable increase starts from φ(H₂O) =0.67 where the DE value of ZrP dispersion deviates from that of the solvent. At φ(H₂O)=1, the value of μₑₚ is remarkably enhanced, which indicate that the surface of ZrP is heavily ionized and its dielectric property become significantly different even from the very polar solvent (H₂O). Therefore, ZrP NPs can not remain stable at this condition.

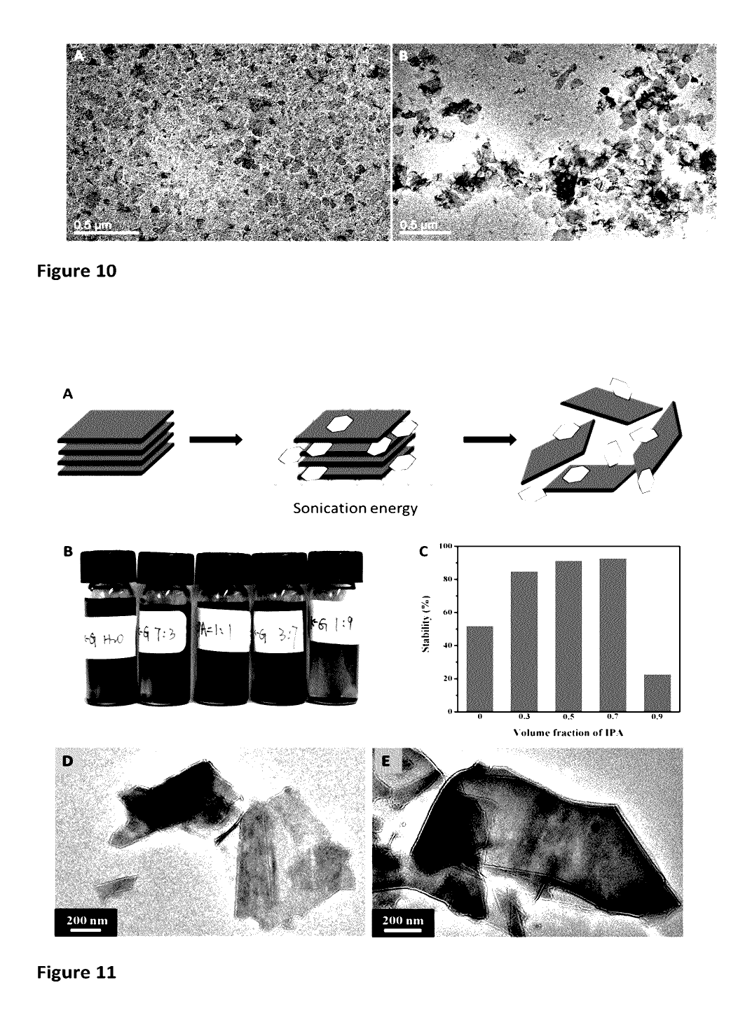

One of the important prerequisites for making polymer/filler nanocomposite with good nano-filler dispersion is the original dispersion state of the nano-fillers before mixing with the polymer. For example, when the purified ZrP is imported into polyvinylalcohol (PVA), a water-soluble polymer, the chosen solvent plays a very important role of the eventual dispersion state of ZrP in PVA even after solvent removal. As show in the TEM (FIG. 10), if the ZrP is previously dispersed in ethanol-H₂O mixture with φ(H₂O)=0.67 and introduced into PVA with a 1 to 1 weight ratio between ZrP and PVA, the ZrP is uniformly distributed in the PVA matrix, forming an evenly thin layer on the TEM grid (FIG. 10A). On the contrary, if the ZrP is previously suspended in H₂O, of which the dispersion is not stable even the ZrP has been previously exfoliated; as shown in FIG. 8A, the ZrP tends to form local ensemble after mixing with PVA and shows aggregation (FIG. 10B). Therefore, by shifting the solvent of the surfactant-free ZrP to become less polar instead of using just H₂O, a good dispersion of surfactant-free ZrP in solvent and consequently in water-soluble polymer can be achieved.

Graphene is another important class of layered structure material. However, it has been difficult to produce graphene material through direct exfoliation of graphite, owing to the strong inter-layer interaction between graphene planes. Liquid exfoliation of the graphite has been reported with the assistance of surfactant, polymer or aromatic molecules, with limited success, i.e., low yield of graphene and requirement of a large amount of stabilizer (references 10, 11 and 12). Here, we demonstrate that single layer or few-layered graphene can be acquired by “exfoliating” graphite with another 2-D layered structure, e.g., individualized ZrP nanoplatelets. As illustrated in FIG. 11A, with the assistance of sonication energy, ZrP serves both as a “wedge” that exfoliates the individual graphene flakes from the graphite and as an inorganic stabilizer to stabilize graphene flakes in the selected solvent. The obtained graphene, ZrP and unexfoliated graphite can be separated through sequential centrifugation. This method generates high yield of high quality of graphene that can be stabilized by solvent chosen using the dielectric-constant tuning technique. FIG. 11B shows the photographs of graphene transferred into a series binary mixture of H₂O and isopropanol. From left to right, φ(isopropanol) equals 0, 0.3, 0.5, 0.7 and 0.9. It is found that when φ(isopropanol) is between 0.5 and 0.7, graphene has best stability as verified by optical spectroscopy that measures the amount of graphene in the supernatant of the different H₂O-isopranol dispersions of graphene (FIG. 11C). TEM micrographs show that graphene exists mainly as a single layer or few-layer structure after the processing (FIG. 11D and 11E).

6. Hybrid NPs

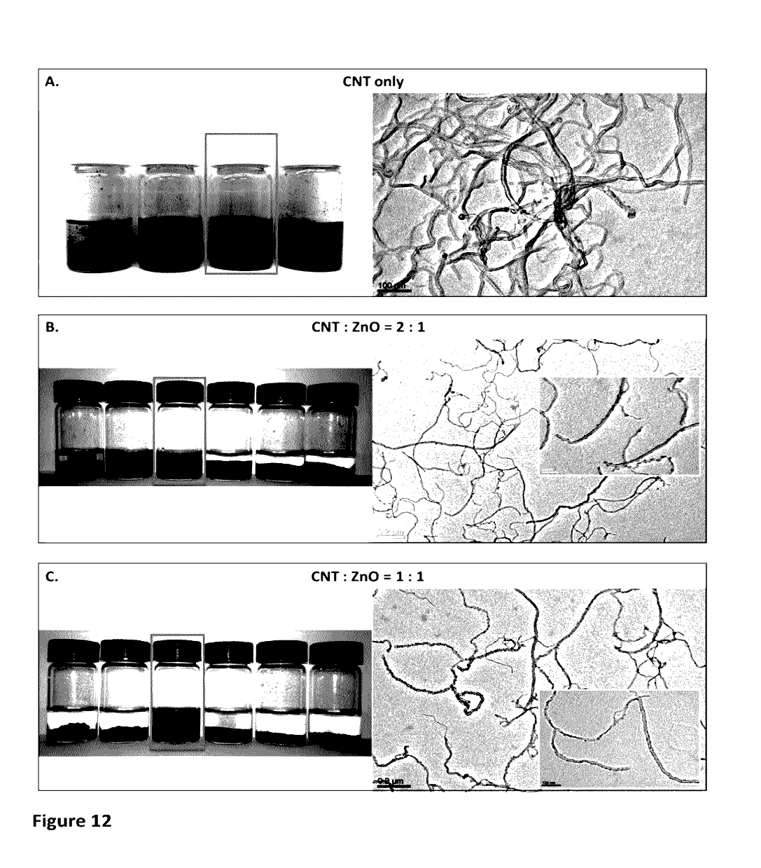

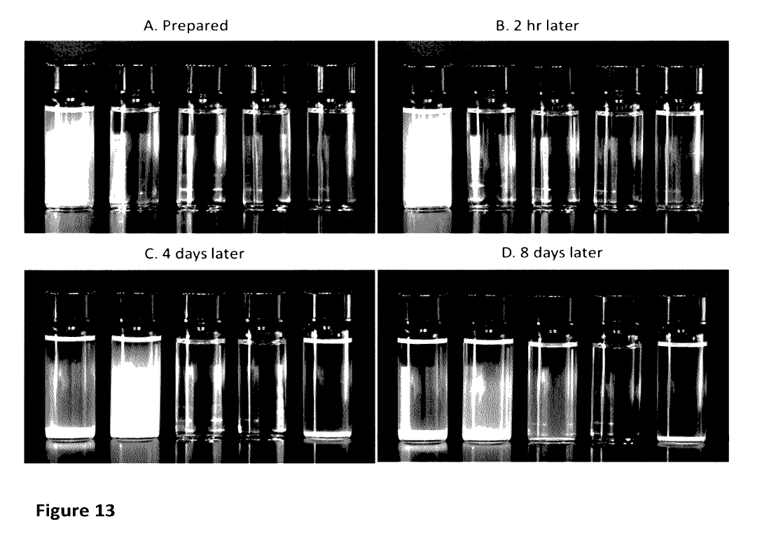

The solvent stabilization approach can also be extended to hybrid particles to improve their stability and dispersion efficiency if one component of the hybrid particles is being dispersed/stabilized by the other(s). For example, when the previously mentioned ZnO SFNPs were mixed with CNTs, ZnO spontaneously attached to the CNT surface. By adjusting the ratio between CNT and ZnO, a series of ZnO—CNT hybrid SFNPs that have different dielectric properties can be created and accordingly can be stabilized in different solvents. As shown in FIG. 12, when pristine multi-walled CNTs (MWCNTs, Southwest branded) were introduced into 2-propanol, 1-butanol, 2-butanol and 1-pentanol (from left to right, DE increasing hereinafter), MWCNTs can only maintain stability in 2-butanol as highlighted by the red rectangle and exists in entangled state as shown by TEM (FIG. 12A). When MWCNTs and ZnO were mixed at a 2:1 ratio (CNT2ZnO1) and dispersed in ethanol, 1-propanol, 1-butanol, 1-pentanol, 1-hexanol and 1-heptanol, 1-butanol was found to be the good solvent and MWCNTs are individualized (FIG. 12B). The inset is magnified TEM micrograph to show that ZnO is attached onto the CNT surface. When MWCNTs and ZnO were mixed at a 1:1 ratio (CNT1ZnO1) and dispersed in ethanol, 1-propanol, 2-propanol, 1-butanol, 1-pentanol & 1-hexanol, 2-propanol stabilizes the MWCNTs best. Also, TEM shows that more ZnO is now coated on CNT. We have also found that when MWCNTs and ZnO were mixed at a 1:2 ratio, methanol is a good stabilizing solvent. The results indicate that ZnO can serve as a dispersing and stabilizing agent for MWCNTs and by adjusting the solvent composition, the ZnO usage can be minimized and the dispersion efficiency maximized.

Another example of using solvent to stabilized conjugated NPs has been performed on CNT and ZrP hybrids. We previously reported that when using ZrP with a diameter of around 100 nm to exfoliate SWCNTs in aqueous system, the minimum weight ratio between ZrP to SWCNTs is 5 to 1 (references 6, 7, and 13). As mentioned above, we later found out that H₂O is too polar to become a good solvent for SWCNTs. Therefore, we switch the dispersion media for the SWCNT-ZrP system to binary mixture of H₂O and isopropanol. By shifting the media to the nonpolar direction, we successfully achieved similar exfoliation effect on SWCNTs and reduce the weight ratio between ZrP to SWCNTs to 2 to 1, with room for further improvement. Hence, selecting a solvent that has matching dielectric property to the target NP or NP hybrid not only enhances the long-term stability of the NP colloids but also contribute to the dispersion state and the exfoliation efficiency when preparing the individualized NPs.

7. Transfer of SFNPs from a Binary Solvent Mixture to a Single-Component Media

The SFNPs that are well dispersed in a solvent mixture can be transferred into a single-component solvent. For example, to transfer the well-dispersed ZnO SFNPs into a single-component solvent, 4 ml ZnO-M50 with a ZnO loading of 0.4 M was added dropwise under stirring to 4 ml of 1-butanol (ε=17.54), 1-pentanol (ε=14.96), 1-hexanol (ε=13.06), 1-heptanol (ε=11.41) and 1-octanol (ε=10.01) at 80-90° C. The temperature was chosen because it is above the boiling points of methanol and dichloromethane and below the boiling points of the chosen alkyl alcohols. The ZnO-M50 was added dropwise to minimize the variation in solvent composition, that is, the addition of methanol and dichloromethane mixture drop by drop to immediately evaporate the solvent mixture before the next drop of solvent mixture is added. The value of ε of the solvents is obtained from the Landolt-Borstein Database hereafter.

FIG. 13 shows the photographical images of the transferred ZnO SFNPs. From left to right, the medium is 1-butanol, 1-pentanol, 1-hexanol, 1-heptanol and 1-octanol, with ε in descending order. None of 1-butanol, 1-pentanol and 1-octanol can provide long term stability of SFNPs. The SFNPs in 1-butanol and 1-pentanol turned turbid during the sample preparation (FIG. 7A) and the SFNPs in 1-octanol turned cloudy in 2 hours (FIG. 7B). ZnO/1-hexanol stayed transparent until 4 days later (FIG. 7C); the transparency of ZnO/1-heptanol maintained after 8 days (FIG. 7D). Again, the ZnO SFNPs in 1-octanol precipitated fast while ZnO SFNPs in 1-hetanol precipitated slower.

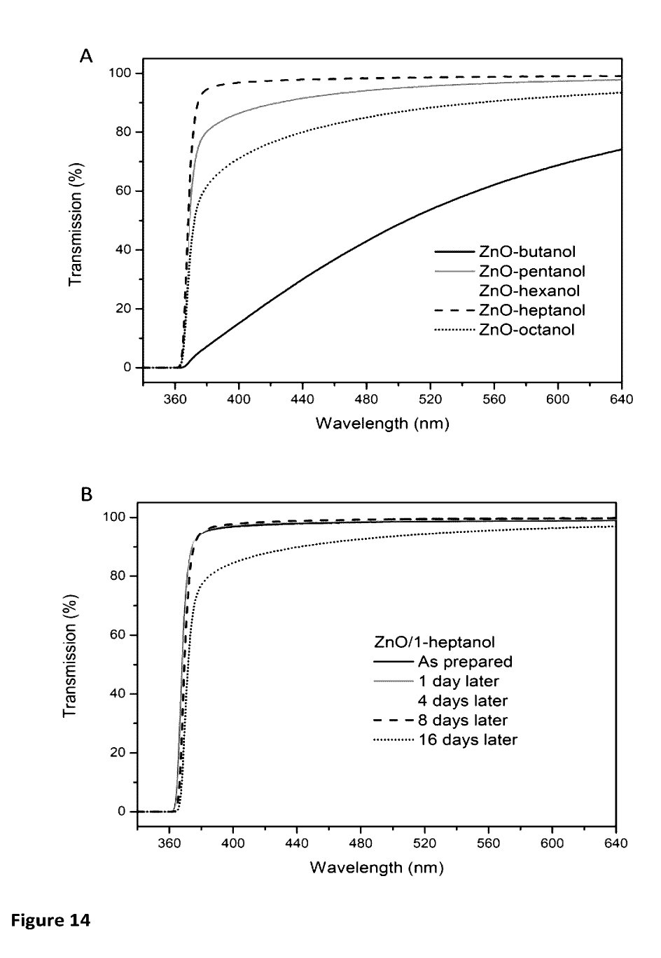

The UV-vis transmission spectra of freshly prepared samples also show that ZnO/1-heptanol is most transparent (FIG. 14A). The results suggest that 1-heptanol is the best solvent for purified ZnO SFNPs. The transmission spectra of SFNPs dispersed in 1-heptanol at different times are shown in FIG. 14B. The ZnO colloids also show a long-term stability up to 8 days. Significant light scattering can be observed 16 days after preparation.

### REFERENCES

These references are incorporated herein by reference in their entireties.
1. K. C. Chang, Y. C. Yeh and J. T. Lue, Measurement, 2012, 45, 808-813.
2. P. C. Hiemena and R. Rajagopalan, Principles of colloid and surface chemistry, Marcel Dekker, Inc., 1997.
3. E. V. Shevchenko, D. V. Talapin, N. A. Kotov, S. O'Brien and C. B. Murray, Nature, 2006, 439, 55-59.
4. D. Sun, M. Wong, L. Sun, Y. Li, N. Miyatake and H. J. Sue, Journal of Sol-Gel Science and Technology, 2007, 43, 237-243.
5. W. Tjhen, T. Tamagawa, C. P. Ye, C. C. Hsueh, P. Schiller and D. L. Polla, Micro Electro

Mechanical Systems, 1991, MEMS ‘91, Proceedings. An Investigation of Micro Structures, Sensors, Actuators, Machines and Robots. IEEE, Nara, Japan, 1991.
6. X. Zhang, H.-J. Sue and R. Nishimura, Carbon, 2013, 56, 374-382.
7. X. Zhang, H.-J. Sue and R. Nishimura, Journal of Materials Chemistry, 2012, 22, 6156-6164.
8. L. Sun, W. J. Boo, H. J. Sue and A. Clearfield, New Journal of Chemistry, 2007, 31, 39-43.
9. A. Clearfield, Annual Review of Materials Science, 1984, 14, 205-229.
10. M. Lotya, P. J. King, U. Khan, S. De and J. N. Coleman, Acs Nano, 2010, 4, 3155-3162.
11. J. M. Englert, J. Roehrl, C. D. Schmidt, R. Graupner, M. Hundhausen, F. Hauke and A. Hirsch, Advanced Materials, 2009, 21, 4265-+.
12. A. B. Bourlinos, V. Georgakilas, R. Zboril, T. A. Steriotis, A. K. Stubos and C. Trapalis, Solid State Communications, 2009, 149, 2172-2176.
13. D. Sun, W. N. Everett, C. C. Chu and H. J. Sue, Small, 2009, 5, 2692-2697.

1. A composition comprising a medium and surfactant-free nanoparticles (SFNPs) at different dispersion state or aggregation form, the composition comprising:
(a) a composition of a medium and surfactant-free nanoparticles in primary form, wherein the dielectric constant value (DE value) of the medium is equal to or larger than the intrinsic dielectric constant value (IDE) of the SFNPs and smaller than about 1.5 times of the IDE of the SFNPs,
(b) a composition of a medium and reaction-limited aggregation form of SFNPs, wherein the DE value of the medium is much larger than the IDE of the surfactant-free nanoparticles,
(c) a composition of a medium and diffusion-limited aggregation form of SFNPs, wherein the DE value of the medium is smaller than the IDE of the surfactant-free nanoparticles, and
(d) a composition comprising redispersible aggregation form of surfactant-free nanoparticles, wherein the surfactant-free nanoparticles are induced to aggregate in the diffusion-limited fashion in a medium with a DE value that is smaller than the IDE of the surfactant-free nanoparticles.

2. The composition of claim 1, wherein said SFNPs have at least one dimension that is smaller than about 800 nm.

3. The composition of claim 1, wherein said SFNPs have at least one dimension that is smaller than about 300 nm.

4. The composition of claim 1, wherein said SFNPs have at least one dimension that is smaller than about 50 nm.

5. The composition of claim 1, wherein said SFNPs have at least one dimension that is smaller than about 30 nm.

6. The composition of claim 1, wherein said SFNPs is selected from a single-type of spherical, rod-like, wire-like, tube-like or disk-shape surfactant-free nanoparticles or any combinations thereof.

7. The composition of claim 1, wherein said SFNPs is selected from a type of metal oxide, carbon, or transitional metal phosphate surfactant-free nanoparticles, or a hybrid structure of combination thereof.

8. The composition of claim 1, wherein said SFNPs is selected from spherical zinc oxide nanoparticles, carbon nanotubes, or α-zirconium phosphate nanodisks, or a hybrid structure of combination thereof.

9. The composition of claim 1, wherein said media is a single-component medium or a mixture of two or more miscible media.

10. The composition of claim 1, wherein said media is selected from an alkyl alcohol, an alkane, an arene, a halogen derivative of alkanes or arenes, or a miscible combination thereof.

11. The composition of claim 1, wherein said SFNPs is single layer or few-layered graphene sheets obtained by
(a) sonicating graphite together with another layered nanostructure in a single-component medium or a mixture of two or more miscible media,
(b) centrifuging the obtained mixture of the graphene, unexfoliated graphite, excess layered nanostructure to remove the unexfoliated graphite,
(c) centrifuging the obtained mixture of graphene and layered nanostructure to remove excess layered nanostructure, and
(d) redispersing the obtained graphene or the graphene-layered-nanostructure hybrid in target media.

12. The composition of claim 11, wherein said media is H₂O, alkyl alcohols, acetone, or a combination thereof.

13. The composition of claim 11, wherein said layered nanostructure is a synthetic clay or natural clay.

14. The composition of claim 11, wherein said layered nanostructure is α-ZrP.

15. A composition of polymer and nanostructure obtained by
(a) selecting a polymer matrix that is at least partially soluble in the said media of claim 11,
(b) mixing the polymer and the said composition of claim 11, and
(c) removing the media from the mixture partially or completely.

16. A process to estimate the intrinsic dielectric constant value (IDE) of surfactant-free nanoparticles (SFNPs) by measuring the embodied dielectric constant values (EDE) in a series of media with different dielectric constant values (DE values), the process comprising:
(a) obtaining primary SFNPs by synthesis or surfactant-assisted exfoliation and subsequent surfactant removal,
(b) dispersing the obtained primary SFNPs into a series of media with different DE values,
(c) comparing the difference between the DE values of reference media and that of the mixture which include both SFNPs and the media, and
(d) determining the IDE of the SFNPs at the point of the DE value divergence between the media and the media-SFNP mixture.

17. A process to control the aggregation behavior of surfactant-free nanoparticles (SFNPs) using a selected media, the process comprising:
(a) obtaining stable dispersion of primary SFNPs in a medium with a dielectric constant value (DE value) equal or larger than the intrinsic dielectric constant value (IDE) of the SFNPs but smaller than about 1.5 times of the IDE of the SFNPs,
(b) obtaining reaction-limited aggregation form of the SFNPs in a medium with a DE value that is at least 1.5 times larger than the IDE of the SFNPs,
(c) obtaining diffusion-limited aggregation form of the SFNPs in a medium with a DE value that is smaller than the IDE of the SFNPs, and
(d) obtaining redispersible aggregation form of the SFNPs by inducing the SFNPs to aggregate in a diffusion-limited fashion in a medium with a DE value that is much smaller than the IDE of the SFNPs.

18. A process for replacing the media of a primary surfactant-free nanoparticle (SFNP) colloids with a media with a higher boiling point, the process comprising:
(a) heating the SFNP colloids up to a temperature higher than the boiling point of the current media but lower than that of the replacing media, and simultaneously adding the replacing media.

19. The process according to claim 16, wherein said SFNPs have at least one dimension that is smaller than about 800 nm.

20. The process according to claim 16, wherein said SFNPs have at least one dimension that is smaller than about 300 nm.

21. The process according to claim 16, wherein said SFNPs have at least one dimension that is smaller than about 100 nm.

22. The process according to claim 16, wherein said SFNPs have at least one dimension that is smaller than about 30 nm.

23. The process according to claim 16, wherein said SFNPs is selected from a single-type of spherical, rod-like, wire-like, tube-like or disk-shape SFNPs or any combinations thereof.

24. The process according to claim 16, wherein said SFNPs is selected from a type of metal oxide, carbon, or transitional metal phosphate SFNPs, or a hybrid combination thereof.

25. The process according to claim 16, wherein said SFNPs is selected from spherical zinc oxide nanoparticles, carbon nanotubes, or α-zirconium phosphate nanodisks, or a hybrid combination thereof.

26. The process according to claim 16, wherein said media is a single-component medium or a mixture of 2 or more miscible media.

27. The process according to claim 16, wherein said media is selected from an alkyl alcohol, an alkane, an arene, a halogen derivative of alkanes or arenes, and a miscible combination thereof.
